(19) United States
(12) Patent Application Publication
(10) Pub. No.: US 2001/0018364 A1
(43) Pub. Date: Aug. 30, 2001

(54) TV game apparatus, apparatus having function of notifying user of incoming, and method therefor

(76) Inventor: Kazunari Watanabe, Kanagawa-ken (JP)

Correspondence Address: FITZPATRICK CELLA HARPER & SCINTO, 30 ROCKEFELLER PLAZA, NEW YORK, NY, 10112, US

(21) Appl. No.: 09/758,347

(22) Filed: Jan. 12, 2001

(30) Foreign Application Priority Data
Jan. 17, 2000 (JP) 2000-007878

(51) Int. Cl. G06F 17/00

(52) U.S. Cl. 463/40

(57) ABSTRACT

This invention provides a TV game apparatus capable of reliably notifying a user of incoming that has occurred during a game. The TV game apparatus includes a CD-ROM I/F portion, setting RAM I/F portion, controller I/F portion, AV I/F portion, and dial-up line I/F portion, and these I/F portions are controlled by a control portion. The control portion has a CPU for executing predetermined control and processing in accordance with a control program stored in a ROM. When incoming from a dial-up line is detected through the dial-up line I/F portion during a game, the control portion executes incoming notification processing of generating incoming notification information for notifying the user of this incoming and outputting the incoming notification information to a monitor through the AV I/F portion.

### BACKGROUND OF THE INVENTION

1. Field of the Invention

The present invention relates to a TV game apparatus, an incoming notification method therefor, and a storage medium.

2. Related Background Art

Generally, a TV game apparatus is designed to load the application program (to be referred to as game software hereinafter) of a game from a storage medium represented by a CD-ROM, execute the software, and send game information including image information and voice information, thereby displaying a game window on a monitor. The TV game apparatus has a controller for performing input operation related to the progress of the game. The progress of the game or various kinds of individual information in the game can be set by performing input operation from the controller. The apparatus also has a programmable storage medium represented by a memory chip for storing the set information. At the start of the game, the set information can be read out from the storage medium as needed.

In recent years, an environment is being prepared to allow an information terminal such as a personal computer at an office or home, or even in open air, to easily access the Internet through a telephone line. Accordingly, an environment is established to make information such as news available in real time and also allow many unspecified persons to simultaneously acquire software information including image information and voice information independently of time and place.

Along with the making and establishment of such environments, a TV game apparatus having an additional function of accessing the Internet is becoming available. This allows the TV game apparatus to directly access the Internet and more easily acquire various kinds of information related to game software by downloading.

This TV game apparatus having the Internet access function can access the Internet by connecting a terminal of the TV game apparatus to a telephone line wired in a building and performing a predetermined operation.

A TV game apparatus of a home user is often branch-connected to a telephone line to which a telephone set or facsimile apparatus has already been connected. Even in the state wherein the TV game apparatus and telephone line are connected, the telephone set detects incoming from the telephone line and rings. When the telephone set is hooked off, speech communication is enabled. However, when incoming is detected during a game, the user may be unaware of ringing by the telephone set because he/she is enthusiastic in the game, or because of the volume level of the game.

### SUMMARY OF THE INVENTION

It is an object of the present invention to provide a TV game apparatus capable of reliably notifying a user of incoming during a game, an incoming notification method therefor, and a storage medium.

According to the invention, there is provided a TV game apparatus which accommodates operation means with which a user performs operation related to progress of a game and has an input interface for receiving the user's operation through the operation means and an output interface for transmitting, to a display device, information which forms a game scene of the game on the display device, characterized by comprising incoming detection means for detecting incoming from a dial-up line, a communication interface for performing communication with the dial-up line, and notification means for, upon detecting the incoming from the dial-up line during the game, transmitting incoming notification information representing the incoming to the display device through the output interface.

According to the invention, the TV game apparatus is characterized in that the incoming notification information is image information to be displayed on the display device.

According to the invention, the TV game apparatus is characterized in that the display device has a voice output function, and the incoming notification information is voice information to be output by the voice output function of the display device.

According to the invention, the TV game apparatus is characterized by further comprising game temporary stop means for executing processing of temporarily stopping the game when the incoming from the dial-up line is detected during the game, and game resumption means for executing processing of resuming the temporarily stopped game after the user has responded to the incoming.

According to the invention, the TV game apparatus is characterized in that the operation means can perform input operation of instructing to temporarily stop the game and input operation of instructing to resume the game, the game temporary stop means executes processing of temporarily stopping the game when the incoming from the dial-up line is detected during the game, and the input operation of instructing to temporarily stop the game is performed, and the game resumption means executes processing of resuming the temporarily stopped game after the user has responded to the incoming when the input operation of instructing to resume the game is performed.

According to the invention, the TV game apparatus is characterized in that the apparatus further comprises response end detection means for detecting an end of the user's response to the incoming, the game temporary stop means executes processing of temporarily stopping the game when the incoming from the dial-up line is detected during the game, and the game resumption means executes processing of resuming the temporarily stopped game when the end of the user's response to the incoming is detected.

According to the invention, the TV game apparatus is characterized in that the communication interface comprises connection means for distributing and connecting the dial-up line to the communication interface and a telephone set.

According to the invention, the TV game apparatus is characterized in that the communication interface comprises telephone function means including a handset, detection means for detecting an off-hook/on-hook state of the handset, response means for responding to the incoming upon detecting the off-hook state of the handset, and disconnection means for disconnecting the dial-up line upon detecting the on-hook state of the handset.

According to the invention, the TV game apparatus is characterized in that the communication interface comprises a telephone interface including connection means for connecting a telephone set and the dial-up line, and detection means for detecting an on-hook state of the telephone set.

According to the invention, the TV game apparatus is characterized in that the response end detection means detects that the user's response to the incoming is ended in accordance with detection of the off-hook state by the detection means.

According to the invention, there is provided an incoming notification method for a TV game apparatus which has an input interface for receiving input operation by a user through operation means with which the user performs the input operation related to progress of a game, an output interface for transmitting, to a display device, information which forms a game scene of the game on the display device, and a communication interface for performing communication with a dial-up line, characterized by comprising the steps of detecting incoming from the dial-up line, and upon detecting the incoming from the dial-up line during the game, transmitting incoming notification information representing the incoming to the display device through the output interface.

According to the invention, the incoming notification method for the TV game apparatus is characterized in that the incoming notification information is image information to be displayed on the display device.

According to the invention, the incoming notification method for the TV game apparatus is characterized in that the display device has voice output means, and the incoming notification information is voice information to be output by the voice output means of the display device.

According to the invention, the incoming notification method for the TV game apparatus is characterized by further comprising the steps of executing processing of temporarily stopping the game when the incoming from the dial-up line is detected during the game, and executing processing of resuming the temporarily stopped game after the user has responded to the incoming.

According to the invention, the incoming notification method for the TV game apparatus is characterized in that the operation means can perform input operation of instructing to temporarily stop the game and input operation of instructing to resume the game, processing of temporarily stopping the game is executed when the incoming from the dial-up line is detected during the game, and the input operation of instructing to temporarily stop the game is performed, and processing of resuming the temporarily stopped game is executed after the user has responded to the incoming when the input operation of instructing to resume the game is performed.

According to the invention, the incoming notification method for the TV game apparatus is characterized in that the method further comprises the step of detecting an end of the user's response to the incoming, processing of temporarily stopping the game is executed when the incoming from the dial-up line is detected during the game, and processing of resuming the temporarily stopped game is executed when the end of the user's response to the incoming is detected.

According to the invention, the incoming notification method for the TV game apparatus is characterized in that the communication interface comprises connection means for distributing and connecting the dial-up line to the communication interface and a telephone set.

According to the invention, the incoming notification method for the TV game apparatus is characterized in that the communication interface comprises telephone function means including a handset, detection means for detecting an off-hook/on-hook state of the handset, response means for responding to the incoming upon detecting the off-hook state of the handset, and disconnection means for disconnecting the dial-up line upon detecting the on-hook state of the handset.

According to the invention, the incoming notification method for the TV game apparatus is characterized in that the communication interface comprises a telephone interface including connection means for connecting a telephone set and the dial-up line, and detection means for detecting an on-hook state of the telephone set.

According to the invention, the incoming notification method for the TV game apparatus is characterized in that it is detected in accordance with detection of the on-hook state by the detection means that the user's response to the incoming is ended.

According to the invention, there is provided a storage medium which stores a program for building an incoming notification system on a TV game apparatus which has an input interface for receiving operation by a user through operation means with which the user performs the operation related to progress of a game, an output interface for transmitting, to a display device, information which forms a game scene of the game on the display device, incoming detection means for detecting incoming from a dial-up line, and a communication interface for performing communication with the dial-up line, characterized in that the program comprises a determination module for determining on the basis of an output from the incoming detection means whether incoming from the dial-up line is detected during the game, and a notification module for, upon detecting the incoming from the dial-up line during the game, transmitting incoming notification information representing the incoming to the display device through the output interface.

According to the invention, the storage medium is characterized in that the incoming notification information is image information to be displayed on the display device.

According to the invention, the storage medium is characterized in that the display device has a voice output function, and the incoming notification information is voice information to be output by the voice output function of the display device.

According to the invention, the storage medium is characterized in that the program further comprises a game temporary stop module for executing processing of temporarily stopping the game when the incoming from the dial-up line is detected during the game, and a game resumption module for executing processing of resuming the temporarily stopped game after the user has responded to the incoming.

According to the invention, the storage medium is characterized in that the operation means can perform input operation of instructing to temporarily stop the game and input operation of instructing to resume the game, the game temporary stop module executes processing of temporarily stopping the game when the incoming from the dial-up line is detected during the game, and the input operation of instructing to temporarily stop the game is performed, and the game resumption module executes processing of resuming the temporarily stopped game after the user has responded to the incoming when the input operation of instructing to resume the game is performed.

According to the invention, the storage medium is characterized in that the program further comprises a response end detection module for detecting an end of the user's response to the incoming, the game temporary stop module executes processing of temporarily stopping the game when the incoming from the dial-up line is detected during the game, and the game resumption module executes processing of resuming the temporarily stopped game when the end of the user's response to the incoming is detected.

According to the invention, the storage medium is characterized in that the communication interface comprises connection means for distributing and connecting the dial-up line to the communication interface and a telephone set.

According to the invention, storage medium is characterized in that the communication interface comprises telephone function means including a handset, detection means for detecting an off-hook/on-hook state of the handset, response means for responding to the incoming upon detecting the off-hook state of the handset, and disconnection means for disconnecting the dial-up line upon detecting the on-hook state of the handset.

According to the invention, storage medium is characterized in that the communication interface comprises a telephone interface including connection means for connecting a telephone set and the dial-up line, and detection means for detecting an on-hook state of the telephone set.

### BRIEF DESCRIPTION OF THE DRAWINGS

FIG. 1 is a view showing the outer appearance of a TV game apparatus according to the first embodiment of the present invention;

FIG. 2 is a block diagram showing the functional arrangement of the TV game apparatus shown in FIG. 1;

FIG. 3 is a block diagram showing the arrangement of a dial-up line I/F portion arranged in the TV game apparatus shown in FIG. 2;

FIG. 4 is a flow chart showing the procedure of incoming notification processing in the TV game apparatus shown in FIG. 1;

FIG. 5 is a view showing the outer appearance of a TV game apparatus according to the second embodiment of the present invention;

FIG. 6 is a block diagram showing the arrangement of a dial-up line I/F portion arranged the TV game apparatus shown in FIG. 5;

FIG. 7 is a flow chart showing the procedure of incoming notification processing in the TV game apparatus shown in FIG. 5;

FIG. 8 is a flow chart showing the procedure of incoming notification processing in the TV game apparatus shown in FIG. 5;

FIG. 9 is a view showing the outer appearance of a TV game apparatus according to the third embodiment of the present invention;

FIG. 10 is a block diagram showing the arrangement of a dial-up line I/F portion arranged in the TV game apparatus shown in FIG. 9; and

FIG. 11 is a block diagram showing an arrangement of a control portion which is separated to two parts.

### DETAILED DESCRIPTION OF THE PREFERRED EMBODIMENTS

The embodiments of the present invention will be described below with reference to the accompanying drawings.

(First Embodiment)

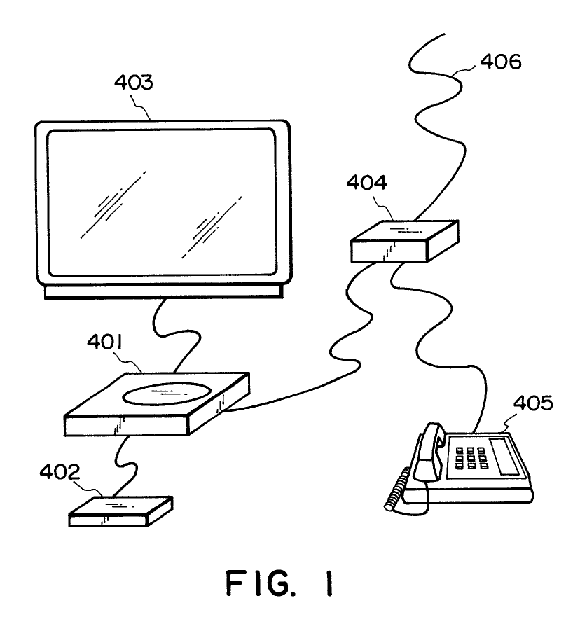

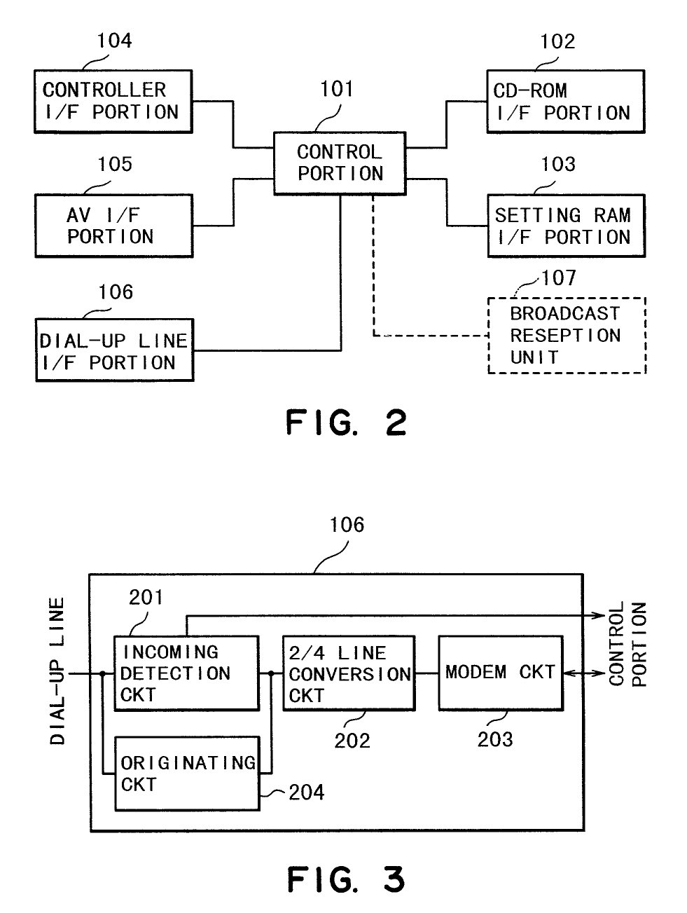

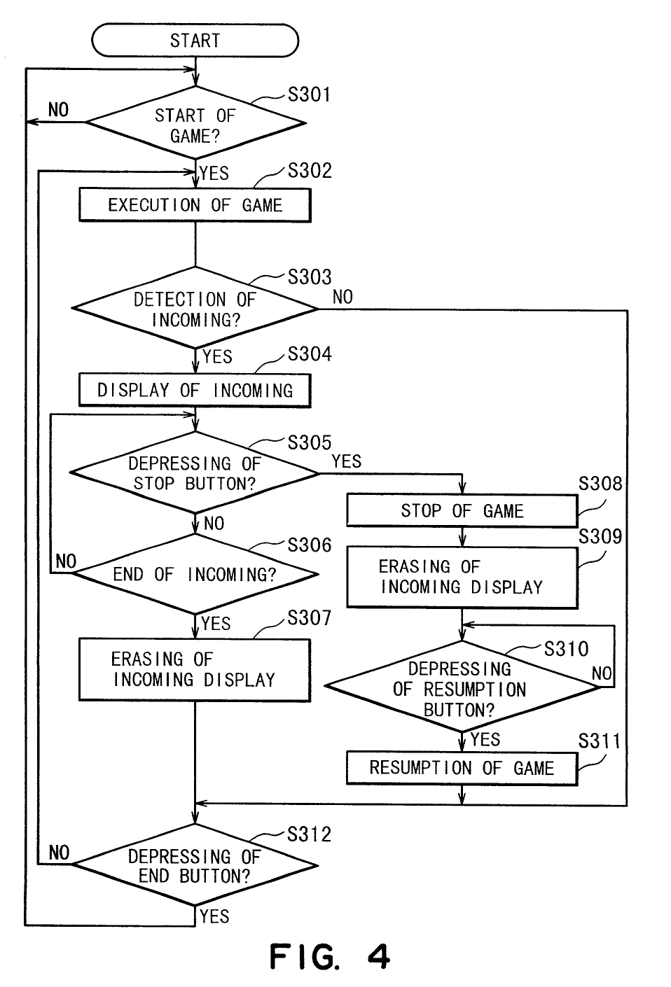

FIG. 1 is a view showing the outer appearance of system including a TV game apparatus according to the first embodiment of the present invention. FIG. 2 is a block diagram showing the functional arrangement of the TV game apparatus shown in FIG. 1. FIG. 3 is a block diagram showing the arrangement of a dial-up line I/F portion arranged in the TV game apparatus shown in FIG. 2.

As shown in FIG. 1, the TV game apparatus comprises an apparatus main body 401 connected to a display device 403 of a TV or the like, which serves as a monitor for displaying received broadcast contents or outputting video or voice data of game software, to output video and voice signals to the monitor 403, a controller 402 having a plurality of operation buttons with which the user performs operation related to the progress of a game to, e.g., start or end the game, and a distributor 404 for distributing a dial-up line (e.g., an analog line) 406 to the apparatus main body 401 and telephone set 405.

As shown in FIG. 2, the apparatus main body 401 incorporates a CD-ROM interface portion (to be referred to as a CD-ROM I/F portion hereinafter) 102 for read-controlling information on a CD (Compact Disk), a setting RAM interface portion (to be referred to as a setting RAM I/F portion hereinafter) 103, a controller interface portion (to be referred to as a controller I/F portion hereinafter) 104, an audio/visual interface portion (to be referred to as an AV I/F portion hereinafter) 105, and a dial-up line interface portion (to be referred to as a dial-up line I/F portion hereinafter) 106.

The CD-ROM I/F portion 102 accommodates a player for playing a CD-ROM on which game software or video information is written, and has a function of driving this player to read out the game software from the CD-ROM. In this embodiment, a CD-ROM is used as a storage medium for supplying game software. Instead, a DVD-ROM may be used as a storage medium for supplying game software. In this case, a player capable of playing a DVD-ROM is used.

The setting RAM I/F portion 103 has a slot to/from which a memory card can be inserted/removed, and performs write/read operation for the memory card inserted to the slot. The contents of the game are temporarily written on this memory card, or individually set contents are written on this memory card. The progress state or set contents of each game can be read out from the memory card as needed. By reading out the progress state or set contents of each game from the memory card, even when the game is interrupted, it can be resumed later from the interrupt point. When the memory card is inserted to another TV game apparatus, the game can be played in this TV game apparatus as well on the basis of the same set contents.

The controller I/F portion 104 is an interface connected to the controller 402 (shown in FIG., 1) and generates a signal according to operation of each operation button of the controller 402.

The AV I/F portion 105 is an interface for converting, e.g., input information into a signal complying with the NTSC standard to send a monitor signal, and outputting the signal to the monitor 403 (shown in FIG. 1). Signals to be output to the monitor 403 include signals such as a video signal that forms a game window and a voice signal, a signal representing an image acquired by the Internet function, and a video signal representing incoming notification information generated by incoming notification processing (to be described later).

The dial-up line I/F portion 106 is an interface for connecting the dial-up line distributed by the distributor 404 (shown in FIG. 1). Main functions of this interface are a function of executing Internet connection using the dial-up line 406, and a function of detecting incoming/originating from the dial-up line 406.

The I/F portions such as the CD-ROM I/F portion 102, setting RAM I/F portion 103, controller I/F portion 104, AV I/F portion 105, and dial-up line I/F portion 106 are controlled by a control portion 101. The control portion 101 has a CPU (not shown) for executing predetermined control and processing in accordance with a control program for, e.g., a control procedure shown in FIG. 4, which is stored in a ROM (not shown).

More specifically, the control portion 101 receives game software read out from a CD-ROM through the CD-ROM I/F portion 102 and executes processing of generating a game window in accordance with the game software. This processing includes processing of performing control related to the progress of the game in accordance with operation on the controller 402, which is input through the controller I/F portion 104. The control portion 101 also controls the operation of the setting RAM I/F portion 103 such that information is written/read on/from a memory card in accordance with operation on the controller 402, which is input through the controller I/F portion 104. The control portion 101 also performs control to execute Internet-connection through the dial-up line I/F portion 106 and download corresponding information from the Internet, as needed. Upon detecting incoming from the dial-up line 406 through the dial-up line I/F portion 106 during the game, the control portion 101 executes incoming notification processing of generating incoming notification information for notifying the user of this incoming and outputting the information to the monitor 403 through the AV I/F portion 105. This incoming notification processing will be described later in detail.

The arrangement of the dial-up line I/F portion 106 will be described next in detail. As shown in FIG. 3, the dial-up line I/F portion 106 has an incoming detection circuit 201 connected to the dial-up line 406 distributed through the distributor 404 to detect incoming from the dial-up line 406, a 2/4 line conversion circuit 202 for converting two lines into four lines separated for transmission and reception to transmit/receive a signal to/from the dial-up line 406, a modem circuit 203 having one terminal connected to the four lines separated by the 2/4 line conversion circuit 202 and the other terminal connected to the control portion 101, and an originating circuit 204 for originating a signal to a public telephone circuit. Upon detecting incoming from the dial-up line 406, the incoming detection circuit 201 outputs a signal representing the detection of the signal to the control portion 101. In dial-up connection to a provider for providing an Internet connection service, the modem circuit 203 performs protocol processing for connection to the provider or protocol processing for communication through the originating circuit 204 or the like.

Incoming notification processing in the TV game apparatus will be described next with reference to FIG. 4. FIG. 4 is a flow chart showing the procedure of incoming notification processing in the TV game apparatus shown in FIG. 1. This incoming notification processing is executed by the control portion 101 in accordance with a control program stored in a ROM.

Upon power-on, the start of a game is waited in step S301, as shown in FIG. 4. When the game starts, the flow advances to step S302 to execute the game. The flow advances to step S303 to determine on the basis of the output signal from the incoming detection circuit 201 whether incoming from the dial-up line 406 is detected. If NO in step S303, the flow advances to step S312 to determine whether the game is ended by depressing the end button. If NO in step S312, the flow returns to step S302 to progress the game. The flow advances to incoming check to detect incoming. If YES in step S312, the flow returns to step S301 to wait the next game start.

If it is determined in step S303 that incoming is detected, the flow advances to step S304 to output incoming notification information to the monitor 403 through the AV I/F portion 105. Thus, an image corresponding to the incoming notification information is displayed on the monitor 403 together with the game image, so the user can be notified of the presence of incoming by this image. The image corresponding to the incoming notification information is displayed while being overlapped on the game window. Setting is possible to display the image at an arbitrary position such as the central position or corner position of the game window. If incoming is detected, the telephone set connected to the dial-up line 406 through the distributor 404 rings.

Next, the flow advances to step S305 to determine whether a button functioning as a stop button on the controller 402 is depressed. If NO in step S305, the flow advances to step S306 to determine whether the originator's on-hook operation for the incoming has been performed, i.e., incoming is ended. If NO in step S306, the flow returns to step S305. To the contrary, if YES in step S306, the flow advances to step S307 to stop outputting the incoming notification information and erase display of the image on the monitor 403, which corresponds to the incoming notification information. Then, the flow advances to step S312 to determine whether the game is ended.

If YES in step S305, the flow advances to step S308 to temporarily stop the game. While keeping the game temporarily stopped, the user can respond to the incoming using the telephone set 405. That is, while keeping the game temporarily stopped, the user can make speech communication using the telephone set 405. In step S309, output of the incoming notification information is stopped, and display of the image on the monitor 403, which corresponds to the incoming notification information, is erased.

In step S310, depressing of a button functioning as a resumption button on the controller 402 is waited. When the button functioning as the resumption button is depressed, it is determined that the user's response to the incoming is ended, and the flow advances to step S311 to resume the game. The flow advances to step S303.

As described above, in this embodiment, when incoming is detected during the game, an image corresponding to the incoming notification information is displayed on the monitor 403. Hence, the user can be reliably notified of incoming that has occurred during the game.

In this embodiment, when incoming is detected during the game, an image corresponding to incoming notification information is displayed on the monitor 403. Instead of displaying the image, a voice representing that incoming has occurred may be generated. Alternatively, an image and voice corresponding to the incoming notification information may be output to the monitor 403.

(Second Embodiment)

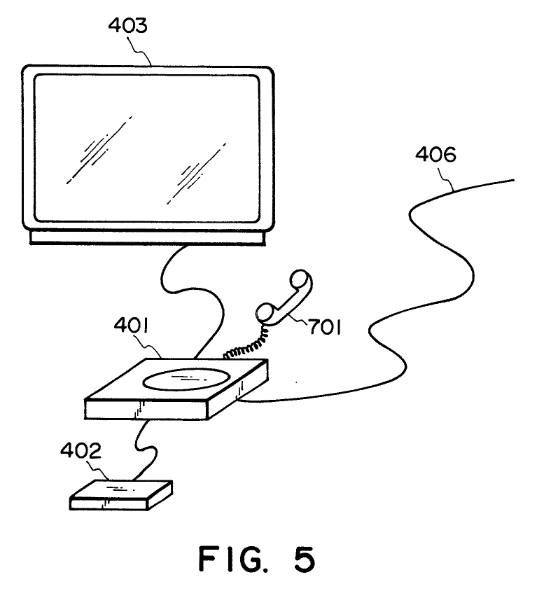

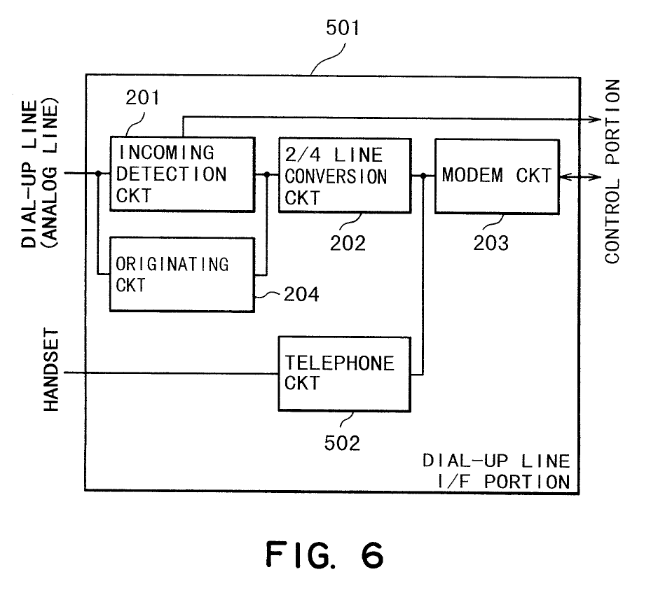

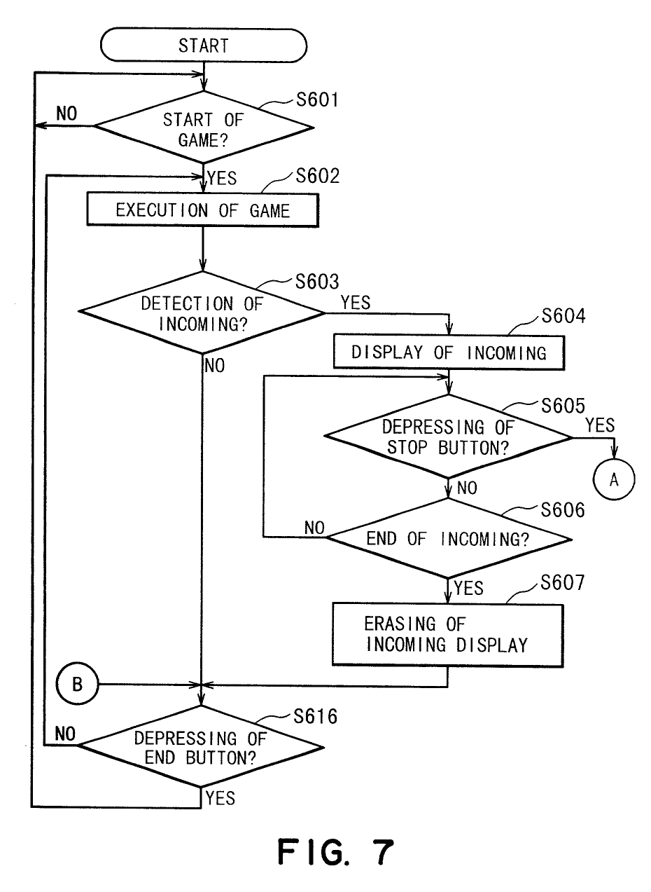

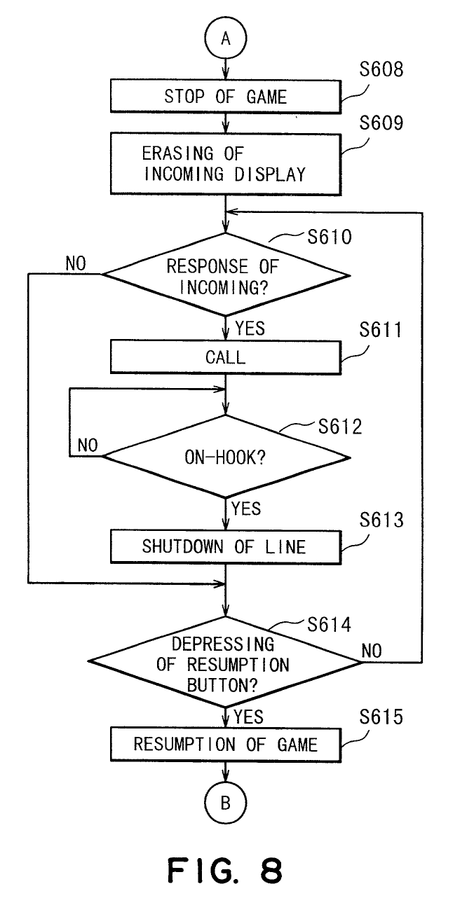

The second embodiment of the present invention will be described next with reference to FIGS. 5 to 8. FIG. 5 is a view showing the outer appearance of a TV game apparatus according to the second embodiment of the present invention. FIG. 6 is a block diagram showing the arrangement of a dial-up line I/F portion arranged the TV game apparatus shown in FIG. 5. FIGS. 7 and 8 are flow charts showing the procedure of incoming notification processing in the TV game apparatus shown in FIG. 5.

The second embodiment is different from the above-described first embodiment in that a telephone function is added. More specifically, as shown in FIG. 5, the TV game apparatus according to this embodiment comprises an apparatus main body 401 for outputting a video signal and voice signal to a monitor 403, and a controller 402 connected to the apparatus main body 401 and having a plurality of operation buttons with which the user performs operation related to the progress of a game to, e.g., start or end the game. A handset 701 is connected to the apparatus main body 401, and a dial-up line 406 is directly connected to the apparatus main body 401.

The apparatus main body 401 incorporates a CD-ROM I/F portion, setting RAM I/F portion, controller I/F portion, AV I/F portion, and dial-up line interface portion 501 (shown in FIG. 6), as in the above-described first embodiment.

The arrangement of the dial-up line I/F portion 501 of this embodiment will be described in detail. As shown in FIG. 6, the dial-up line I/F portion 501 has an incoming detection circuit 201, 2/4 line conversion circuit 202, modem circuit 203, originating circuit 204, and telephone circuit 502.

The telephone circuit 502 is a circuit for realizing the telephone function. This circuit has a response function for an incoming signal and a speech communication function of making speech communication using the handset 701.

Incoming notification processing in this TV game apparatus will be described next with reference to FIGS. 7 and 8. This incoming notification processing is executed by a control portion 101 in accordance with a control program stored in a ROM.

Upon power-on, the start of a game is waited in step S601, as shown in FIG. 7. When the game starts in step S602, the flow advances to step S603 to determine on the basis of the output signal from the incoming detection circuit 201 whether incoming from the dial-up line 406 is detected. If NO in step S603, the flow advances to step S616 to determine whether a button functioning as a game end button on the controller 402 is depressed. If NO in step S616, the flow returns to step S602 to execute the game and detect incoming. If YES in step S616, the flow returns to step S601 to wait the next game start.

If it is determined in step S603 that incoming is detected, the flow advances to step S604 to output incoming notification information to the monitor 403 through the AV I/F portion 105. Thus, an image corresponding to the incoming notification information is displayed on the monitor 403. Additionally, when this incoming is detected, the telephone circuit 502 rings.

Next, the flow advances to step S605 to determine whether a button functioning as a stop button on the controller 402 is depressed. If NO in step S605, the flow advances to step S606 to determine whether the originator's on-hook operation for the incoming has been performed, i.e., incoming is ended. If NO in step S606, the flow returns to step S605. To the contrary, if YES in step S606, the flow advances to step S607 to stop outputting the incoming notification information and erase display of the image on the monitor 403, which corresponds to the incoming notification information. Then, the flow advances to step S612 to determine the presence of depressing of the button functioning as the game end button.

If YES in step S605, the flow advances to step S608 shown in FIG. 8 to temporarily stop the game. In step S609, output of the incoming notification information is stopped, and display of the image on the monitor 403, which corresponds to the incoming notification information, is erased. The flow advances to step S610 to determine whether the user has responded to the incoming by predetermined operation.

If YES in step S610, the flow advances to step S611 to set the speech communication state. In step S612, the on-hook operation is waited. If the on-hook state is detected, the flow advances to step S613 to disconnect the line. The flow advances to step S614 to determine whether a button functioning as a resumption button on the controller 402 is depressed. If NO in step S614, the flow returns to step S610. If YES in step S614, the flow advances to step S615 to resume the game. The flow advances to step S616.

If NO in step S610, the flow advances to step S614 while skipping steps S611 and S613.

As described above, in this embodiment, when incoming is detected during the game, an image corresponding to the incoming notification information is displayed on the monitor 403. Hence, the user can be reliably notified of incoming that has occurred during the game. In addition, since the telephone circuit 502 is arranged, speech communication can be made by connecting the handset 701. Furthermore, since the apparatus can be directly connected to the dial-up line 406, no distributor 404 need be used, unlike the above-described first embodiment.

(Third Embodiment)

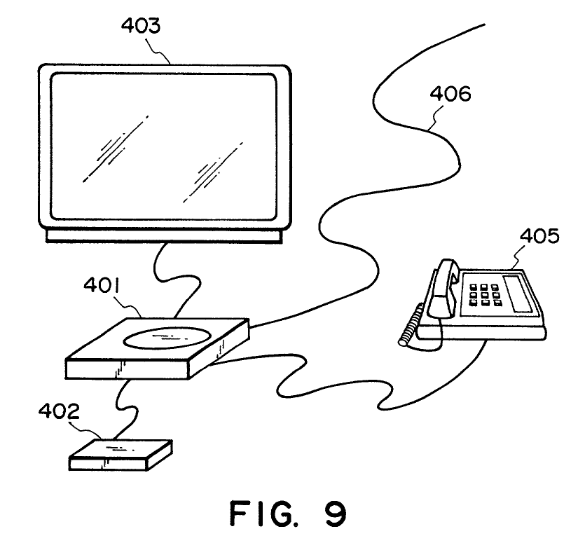

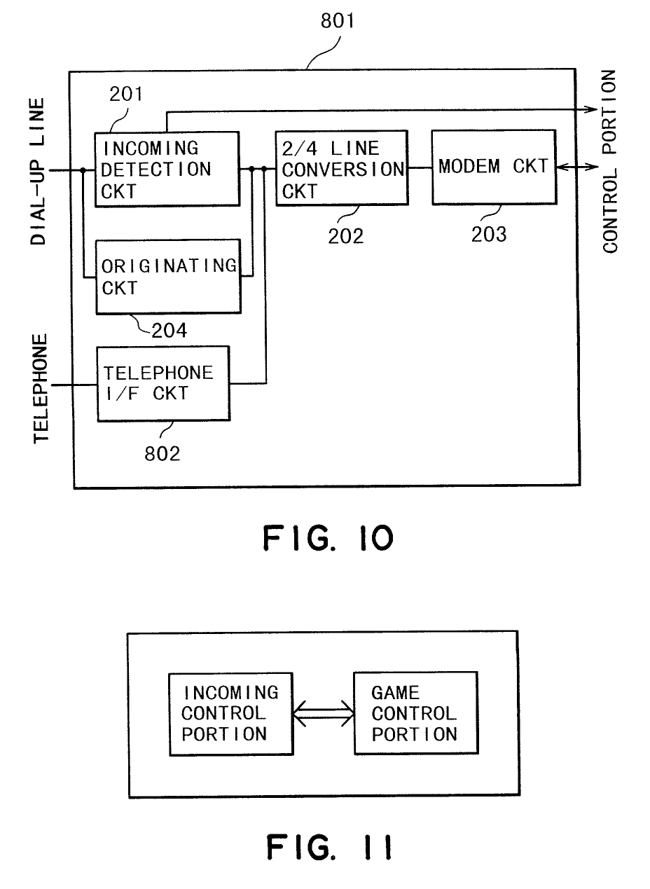

The third embodiment of the present invention will be described next with reference to FIGS. 9 and 10. FIG. 9 is a view showing the outer appearance of a TV game apparatus according to the third embodiment of the present invention. FIG. 10 is a block diagram showing the arrangement of a dial-up line I/F portion arranged the TV game apparatus shown in FIG. 9.

The third embodiment is different from the above-described first embodiment in that a function of connecting a telephone set is added to the dial-up line I/F portion.

More specifically, as shown in FIG. 9, the TV game apparatus according to this embodiment comprises an apparatus main body 401 and a controller 402. A dial-up line 406 is directly connected to the apparatus main body 401, and a telephone set 405 is also connected to the apparatus main body 401.

The apparatus main body 401 incorporates a CD-ROM I/F portion, setting RAM I/F portion, controller I/F portion, AV I/F portion, and dial-up line interface portion 801 (shown in FIG. 10), as in the above-described first embodiment.

The arrangement of the dial-up line I/F portion 801 of this embodiment will be described in detail. As shown in FIG. 10, the dial-up line I/F portion 801 has an incoming detection circuit 201, 2/4 line conversion circuit 202, modem circuit 203, originating circuit 204, and telephone I/F circuit 802. The telephone I/F circuit 802 is a circuit for connecting the external telephone set 405 and performs operation of switching the dial-up line 406 between the telephone set 405 side and the modem side.

As described above, in this embodiment, since the telephone I/F circuit 802 is arranged, the telephone set 405 can be connected without using the distributor 404, unlike the above-described first embodiment.

In the above-described embodiments, the game is temporarily stopped and resumed by operating the controller 402. Alternatively, the game may be automatically stopped upon detecting incoming during the game, and the temporarily stopped game may be automatically resumed upon detecting the end of user's response to the incoming.

In the above embodiments, incoming check and game execution are alternately performed. However, when the control portion is separated to two parts, as shown in FIG. 11, the incoming control portion controls display of incoming in accordance with a game start/end signal from the game control portion, and the game control portion side only need execute the game program and send a start/end signal to the incoming control portion. This provides an effect different from the above embodiments.

In the above embodiments, a call is received when game software is being executed. However, a broadcast reception unit 107 is connected to the control portion 101, as shown in FIG. 2, to display a message representing an incoming signal overlapped on a video signal of broadcast. For this reason, when incoming is detected during reception of TV broadcast, the incoming can be displayed. In addition, troubles on speech communication by the telephone set can be prevented by suppressing voice information from the broadcast reception unit on the basis of an incoming signal.

In the above-described embodiments, the program corresponding to incoming notification processing is stored in ROM of the control portion 101. This program may be stored in an external storage medium (DVD-ROM, CD-ROM, memory card, or the like). In this case, since the CPU of the control portion 101 reads the program from the external storage medium and executes it to achieve the object of the present invention, the storage medium which stores the program constitutes the present invention. The program may be distributed through the Internet.

Even when the program corresponding to the above-described incoming notification processing is stored in a general computer, the same effect as that of the present invention can be obtained on this computer. For example, when incoming is detected during execution of game software on the computer connected to a dial-up line, the user can be reliably notified of this incoming by the program corresponding to the incoming notification processing.

As has been described above, the TV game apparatus of the present invention comprises an incoming detection means for detecting incoming from a dial-up line, a communication interface for performing communication with the dial-up line, and a notification means for, upon detecting the incoming from the dial-up line during the game, transmitting incoming notification information representing the incoming to the display device through the output interface. Hence, when incoming has occurred during the game, the user can be reliably notified of this incoming.

The incoming notification information can be image information to be displayed on the display device. The display device has a voice output function, and the incoming notification information can be voice information to be output by the voice output function of the display device.

The apparatus further comprises a game temporary stop means for executing processing of temporarily stopping the game when the incoming from the dial-up line is detected during the game, and a game resumption means for executing processing of resuming the temporarily stopped game after the user has responded to the incoming. Hence, the game temporarily stopped for the response to the incoming can be easily resumed.

The operation means can perform input operation of instructing to temporarily stop the game and input operation of instructing to resume the game, the game temporary stop means executes processing of temporarily stopping the game when the incoming from the dial-up line is detected during the game, and the input operation of instructing to temporarily stop the game is performed, and the game resumption means executes processing of resuming the temporarily stopped game after the user has responded to the incoming when the input operation of instructing to resume the game is performed. Hence, the game can be temporarily stopped at a desired timing to respond to the incoming, and the temporarily stopped game can be resumed at a desired timing.

The apparatus further comprises a response end detection means for detecting an end of the user's response to the incoming, the game temporary stop means executes processing of temporarily stopping the game when the incoming from the dial-up line is detected during the game, and the game resumption means executes processing of resuming the temporarily stopped game when the end of the user's response to the incoming is detected. Hence, the game can be easily temporarily stopped and resumed without user's operation.

The communication interface comprises a connection means for distributing and connecting the dial-up line to the communication interface and a telephone set. Hence, the dial-up line can be easily connected to the telephone set.

The communication interface comprises a telephone function means including a handset, a detection means for detecting an off-hook/on-hook state of the handset, a response means for responding to the incoming upon detecting the off-hook state of the handset, and a disconnection means for disconnecting the dial-up line upon detecting the on-hook state of the handset. Hence, no telephone set need be newly prepared.

The communication interface comprises a telephone interface including a connection means for connecting a telephone set and the dial-up line, and a detection means for detecting an on-hook state of the telephone set. Hence, the telephone set can be easily connected, and the end of user's response to the incoming can be detected.

The response end detection means can be designed to detect that the user's response to the incoming is ended in accordance with detection of the on-hook state by the detection means.

An incoming notification method for a TV game apparatus of the present invention comprises the steps of detecting incoming from the dial-up line, and upon detecting the incoming from the dial-up line during the game, transmitting incoming notification information representing the incoming to the display device through the output interface. Hence, when incoming has occurred during the game, the user can be reliably notified of this incoming.

The incoming notification information can be image information to be displayed on the display device. The display device has a voice output function, and the incoming notification information can be voice information to be output by the voice output function of the display device.

The method according further comprises the steps of executing processing of temporarily stopping the game when the incoming from the dial-up line is detected during the game, and executing processing of resuming the temporarily stopped game after the user has responded to the incoming. Hence, the game temporarily stopped for the response to the incoming can be easily resumed.

The operation means can perform input operation of instructing to temporarily stop the game and input operation of instructing to resume the game, processing of temporarily stopping the game is executed when the incoming from the dial-up line is detected during the game, and the input operation of instructing to temporarily stop the game is performed, and processing of resuming the temporarily stopped game is executed after the user has responded to the incoming when the input operation of instructing to resume the game is performed. Hence, the game can be temporarily stopped at a desired timing to respond to the incoming, and the temporarily stopped game can be resumed at a desired timing.

The method further comprises the step of detecting an end of the user's response to the incoming, processing of temporarily stopping the game is executed when the incoming from the dial-up line is detected during the game, and processing of resuming the temporarily stopped game is executed when the end of the user's response to the incoming is detected. Hence, the game can be easily temporarily stopped and resumed without user's operation.

The communication interface comprises a connection means for distributing and connecting the dial-up line to the communication interface and a telephone set. Hence, the dial-up line can be easily connected to the telephone set.

The communication interface comprises a telephone function means including a handset, a detection means for detecting an off-hook/on-hook state of the handset, a response means for responding to the incoming upon detecting the off-hook state of the handset, and a disconnection means for disconnecting the dial-up line upon detecting the on-hook state of the handset. Hence, no telephone set need be newly prepared.

The communication interface comprises a telephone interface including a connection means for connecting a telephone set and the dial-up line, and a detection means for detecting an on-hook state of the telephone set. Hence, the telephone set can be easily connected, and the end of user's response to the incoming can be detected.

The method can also be designed to detect that the user's response to the incoming is ended in accordance with detection of the on-hook state by the detection means.

According to the storage medium of the present invention, the program comprises a determination module for determining on the basis of an output from an incoming detection means whether incoming from the dial-up line is detected during the game, and a notification module for, upon detecting the incoming from the dial-up line during the game, transmitting incoming notification information representing the incoming to the display device through the output interface. Hence, when incoming has occurred during the game, the user can be reliably notified of this incoming.

The incoming notification information can be image information to be displayed on the display device. The display device has a voice output function, and the incoming notification information can be voice information to be output by the voice output function of the display device.

The program further comprises a game temporary stop module for executing processing of temporarily stopping the game when the incoming from the dial-up line is detected during the game, and a game resumption module for executing processing of resuming the temporarily stopped game after the user has responded to the incoming. Hence, the game temporarily stopped for the response to the incoming can be easily resumed.

The operation means can perform input operation of instructing to temporarily stop the game and input operation of instructing to resume the game, the game temporary stop module executes processing of temporarily stopping the game when the incoming from the dial-up line is detected during the game, and the input operation of instructing to temporarily stop the game is performed, and the game resumption module executes processing of resuming the temporarily stopped game after the user has responded to the incoming when the input operation of instructing to resume the game is performed. Hence, the game can be temporarily stopped at a desired timing to respond to the incoming, and the temporarily stopped game can be resumed at a desired timing.

The program further comprises a response end detection module for detecting an end of the user's response to the incoming, the game temporary stop module executes processing of temporarily stopping the game when the incoming from the dial-up line is detected during the game, and the game resumption module executes processing of resuming the temporarily stopped game when the end of the user's response to the incoming is detected. Hence, the game can be easily temporarily stopped and resumed without user's operation.

The communication interface comprises a connection means for distributing and connecting the dial-up line to the communication interface and a telephone set. Hence, the dial-up line can be easily connected to the telephone set.

The communication interface comprises a telephone function means including a handset, a detection means for detecting an off-hook/on-hook state of the handset, a response means for responding to the incoming upon detecting the off-hook state of the handset, and a disconnection means for disconnecting the dial-up line upon detecting the on-hook state of the handset. Hence, no telephone set need be newly prepared.

The communication interface comprises a telephone interface including a connection means for connecting a telephone set and the dial-up line, and a detection means for detecting an on-hook state of the telephone set. Hence, the telephone set can be easily connected, and the end of user's response to the incoming can be detected.

The response end detection module can also be designed to detect that the user's response to the incoming is ended in accordance with detection of the on-hook state by the detection means.

What is claimed is:

1. A TV game apparatus which accommodates operation means with which a user performs operation related to progress of a game and has an input interface for receiving the user's operation through said operation means and an output interface for transmitting, to a display device, information which forms a game scene of the game on the display device, characterized by comprising:
incoming detection means for detecting incoming from a dial-up line;
a communication interface for performing communication with the dial-up line; and
notification means for, upon detecting the incoming from the dial-up line during the game, transmitting incoming notification information representing the incoming to the display device through the output interface.

2. An apparatus according to claim 1, characterized in that the incoming notification information is image information to be displayed on the display device.

3. An apparatus according to claim 1, characterized in that
the display device has a voice output function, and
the incoming notification information is voice information to be output by the voice output function of the display device.

4. An apparatus according to any one of claims 1 to 3, characterized by further comprising
game temporary stop means for executing processing of temporarily stopping the game when the incoming from the dial-up line is detected during the game, and
game resumption means for executing processing of resuming the temporarily stopped game after the user has responded to the incoming.

5. An apparatus according to claim 4, characterized in that
said operation means can perform input operation of instructing to temporarily stop the game and input operation of instructing to resume the game,
said game temporary stop means executes processing of temporarily stopping the game when the incoming from the dial-up line is detected during the game, and the input operation of instructing to temporarily stop the game is performed, and
said game resumption means executes processing of resuming the temporarily stopped game after the user has responded to the incoming when the input operation of instructing to resume the game is performed.

6. An apparatus according to claim 4, characterized in that
said apparatus further comprises response end detection means for detecting an end of the user's response to the incoming,
said game temporary stop means executes processing of temporarily stopping the game when the incoming from the dial-up line is detected during the game, and
said game resumption means executes processing of resuming the temporarily stopped game when the end of the user's response to the incoming is detected.

7. An apparatus according to claim 1, characterized in that the communication interface comprises connection means for distributing and connecting the dial-up line to the communication interface and a telephone set.

8. An apparatus according to claim 1, characterized in that said communication interface comprises telephone function means including a handset, detection means for detecting an off-hook/on-hook state of said handset, response means for responding to the incoming upon detecting the off-hook state of said handset, and disconnection means for disconnecting the dial-up line upon detecting the on-hook state of said handset.

9. An apparatus according to claim 1, characterized in that said communication interface comprises a telephone interface including connection means for connecting a telephone set and the dial-up line, and detection means for detecting an on-hook state of the telephone set.

10. An apparatus according to claim 8 or 9, characterized in that said response end detection means detects that the user's response to the incoming is ended in accordance with detection of the off-hook state by said detection means.

11. An incoming notification method for a TV game apparatus which has an input interface for receiving input operation by a user through operation means with which the user performs the input operation related to progress of a game, an output interface for transmitting, to a display device, information which forms a game scene of the game on the display device, and a communication interface for performing communication with a dial-up line, characterized by comprising the steps of:
detecting incoming from the dial-up line; and
upon detecting the incoming from the dial-up line during the game, transmitting incoming notification information representing the incoming to the display device through the output interface.

12. A method according to claim 11, characterized in that the incoming notification information is image information to be displayed on the display device.

13. A method according to claim 11, characterized in that
the display device has voice output means, and
the incoming notification information is voice information to be output by the voice output means of the display device.

14. A method according to any one of claims 11 to 13, characterized by further comprising the steps of
executing processing of temporarily stopping the game when the incoming from the dial-up line is detected during the game, and
executing processing of resuming the temporarily stopped game after the user has responded to the incoming.

15. A method according to claim 14, characterized in that
the operation means can perform input operation of instructing to temporarily stop the game and input operation of instructing to resume the game,
processing of temporarily stopping the game is executed when the incoming from the dial-up line is detected during the game, and the input operation of instructing to temporarily stop the game is performed, and
processing of resuming the temporarily stopped game is executed after the user has responded to the incoming when the input operation of instructing to resume the game is performed.

16. A method according to claim 14, characterized in that
said method further comprises the step of detecting an end of the user's response to the incoming,
processing of temporarily stopping the game is executed when the incoming from the dial-up line is detected during the game, and
processing of resuming the temporarily stopped game is executed when the end of the user's response to the incoming is detected.

17. A method according to claim 11, characterized in that the communication interface comprises connection means for distributing and connecting the dial-up line to the communication interface and a telephone set.

18. A method according to claim 11, characterized in that the communication interface comprises telephone function means including a handset, detection means for detecting an off-hook/on-hook state of the handset, response means for responding to the incoming upon detecting the off-hook state of the handset, and disconnection means for disconnecting the dial-up line upon detecting the on-hook state of the handset.

19. A method according to claim 11, characterized in that the communication interface comprises a telephone interface including connection means for connecting a telephone set and the dial-up line, and detection means for detecting an on-hook state of the telephone set.

20. A method according to claim 18 or 19, characterized in that it is detected in accordance with detection of the off-hook state by the detection means that the user's response to the incoming is ended.

21. A storage medium which stores a program for building an incoming notification system on a TV game apparatus which has an input interface for receiving operation by a user through operation means with which the user performs the operation related to progress of a game, an output interface for transmitting, to a display device, information which forms a game scene of the game on the display device, incoming detection means for detecting incoming from a dial-up line, and a communication interface for performing communication with the dial-up line, characterized in that said program comprises:
a determination module for determining on the basis of an output from the incoming detection means whether incoming from the dial-up line is detected during the game; and
a notification module for, upon detecting the incoming from the dial-up line during the game, transmitting incoming notification information representing the incoming to the display device through the output interface.

22. A medium according to claim 21, characterized in that the incoming notification information is image information to be displayed on the display device.

23. A medium according to claim 21, characterized in that
the display device has a voice output function, and
the incoming notification information is voice information to be output by the voice output function of the display device.

24. A medium according to any one of claims 21 to 23, characterized in that said program further comprises
a game temporary stop module for executing processing of temporarily stopping the game when the incoming from the dial-up line is detected during the game, and
a game resumption module for executing processing of resuming the temporarily stopped game after the user has responded to the incoming.

25. A medium according to claim 24, characterized in that
the operation means can perform input operation of instructing to temporarily stop the game and input operation of instructing to resume the game,
said game temporary stop module executes processing of temporarily stopping the game when the incoming from the dial-up line is detected during the game, and the input operation of instructing to temporarily stop the game is performed, and
said game resumption module executes processing of resuming the temporarily stopped game after the user has responded to the incoming when the input operation of instructing to resume the game is performed.

26. A medium according to claim 24, characterized in that
said program further comprises a response end detection module for detecting an end of the user's response to the incoming,
said game temporary stop module executes processing of temporarily stopping the game when the incoming from the dial-up line is detected during the game, and
said game resumption module executes processing of resuming the temporarily stopped game when the end of the user's response to the incoming is detected.

27. A medium according to claim 21, characterized in that the communication interface comprises connection means for distributing and connecting the dial-up line to the communication interface and a telephone set.

28. A medium according to claim 21, characterized in that the communication interface comprises telephone function means including a handset, detection means for detecting an off-hook/on-hook state of the handset, response means for responding to the incoming upon detecting the off-hook state of the handset, and disconnection means for disconnecting the dial-up line upon detecting the on-hook state of the handset.

29. A medium according to claim 21, characterized in that the communication interface comprises a telephone interface including connection means for connecting a telephone set and the dial-up line, and detection means for detecting an on-hook state of the telephone set.

30. A medium according to claim 28 or 29, characterized in that said response end detection module detects that the user's response to the incoming is ended in accordance with detection of the off-hook state by the detection means.

31. A TV control apparatus which has an input interface for receiving operation by a user through operation means with which the user performs the operation related to execution of software, and an output interface for outputting, to a display device, information that forms a window of the software on the display device, characterized by comprising:
incoming detection means for detecting incoming from a communication line;
a communication interface for performing communication with the communication line; and
notification means for, upon detecting the incoming from the communication line, outputting incoming notification information representing the incoming to the display device through the output interface.

32. A control apparatus which has an input interface for receiving operation by a user through operation means with which the user performs the operation related to execution of software, and an output interface for receiving TV broadcast and outputting information that forms a window of the software on a display device for displaying contents of the broadcast, characterized by comprising:
incoming detection means for detecting incoming from a communication line;
a communication interface for performing communication with the communication line; and
notification means for, upon detecting the incoming from the communication line, outputting incoming notification information representing the incoming to the display device through the output interface.

33. An apparatus according to claim 32, characterized by further comprising a broadcast reception unit for outputting the broadcast to the display device.

34. An apparatus according to claim 33, characterized by comprising the display device for displaying an output from said broadcast reception unit.
